(19) United States
(12) Patent Application Publication
(10) Pub. No.: US 2002/0070845 A1
(43) Pub. Date: Jun. 13, 2002

(54) Method and configuration for remote access control

(76) Inventors: Thomas Reisinger, Regensburg (DE); Christian Schneider, Lappersdorf (DE)

Correspondence Address: LERNER AND GREENBERG, P.A., Post Office Box 2480, Hollywood, FL, 33022-2480, US

(21) Appl. No.: 09/994,195

(22) Filed: Nov. 26, 2001

Related U.S. Application Data
(63) Continuation of application No. PCT/DE00/01639, filed on May 22, 2000.

(30) Foreign Application Priority Data
May 25, 1999 (DE) 199 23 983.5

(51) Int. Cl. H04Q 1/00; G05B 19/00

(52) U.S. Cl. 340/5.61; 340/10.2; 370/342

(57) ABSTRACT

Remote access (for example to a motor vehicle) is controlled with a configuration having a transceiver unit. The transceiver unit outputs an interrogation signal which activates all available access code transmitters at the same time, and all the access code transmitters which receive this interrogation signal then transmit their specific access code signals, essentially at the same time. The transceiver unit separates the access code signals received at the same time on the basis of a characteristic applied to them.

### CROSS-REFERENCE TO RELATED APPLICATION

This application is a continuation of copending International Application No. PCT/DE00/01639, filed May 22, 2000, which designated the United States.

### BACKGROUND OF THE INVENTION

Field of the Invention

The invention relates to a method for remote access control, in particular for radio access control to the interior and/or for activation of operating functions of a motor vehicle. The access control is effected by a configuration provided with a transceiver unit for transmitting an interrogation signal or request signal and for receiving access code signals. An evaluation unit is connected to the transceiver unit, for evaluating received access code signals and for outputting an access enable or inhibit signal as a function of the evaluation result. A number of access code transmitters receive the request signal and transmit a respective specific access code signal as a response to the reception of the interrogation signal. The invention further pertains to a configuration for carrying out the method.

Electronic access control systems have spread surprisingly quickly and widely in a variety of fields in recent years. The functionality of such systems is being continuously further extended. For example, for motor vehicle construction, the classical radio locking systems, which were initially only a convenience function (and were regarded by many car drivers as being superfluous), have now become complex systems not only allowing access to the interior of the vehicle, but also allowing vehicle functions to be controlled. Users are in this case authenticated by transmitting an access code, to be precise by radio in modern systems. It is currently envisaged that user-specific data, which is required to control specific functions, will also be transmitted in addition to the access code.

Advanced access control systems of this type, which are now in practical use in up-market passenger vehicles, provide the principle of passive entry in configurations with a transceiver unit in the vehicle and a number of smart cards which give the holder of the vehicle, his partner or other persons access to the vehicle, allowing them to start this vehicle. These smart cards are not identical to one another, but are individualized. This is based on the principle, inter alia, that certain vehicle functions (for example seat and mirror adjustment) are intended to be carried out on the basis of user-specific data stored on the smart card. Furthermore, security, safety and documentation considerations are a significant factor in this case.

Such smart cards provide, especially, the principle of passive entry and/or passive go, whose essence is that the access code transmitters (smart cards) are activated or polled, on approaching the vehicle, by a transceiver unit in said vehicle, and then transmit an access code to this unit. It is sufficient for the smart card to be carried on the body in order to allow the vehicle to be used. A bidirectional communication takes place between the vehicle and the smart card for vehicle access. For example, the transceiver unit in the vehicle communicates with the smart card via inductive antennas which are accommodated in the doors and the luggage compartment or bumpers. These antennas are actuated using a 125 kHz carrier, while the smart cards produce their response to the vehicle (according to the present prior art) using what is referred to as the ISM frequency band around 433 MHz. Touching the door handle of a secured vehicle results in an interrogation signal being output via the inductive antenna arranged in the corresponding door, in response to which the smart card carried on the body transmits an access code signal (authentication signal) by radio to the vehicle. If the evaluation of the access code confirms its validity, then the vehicle is unlocked via the central locking pump. The process of securing the vehicle when leaving it, the starting of the vehicle (initiated using a touch key in the operating area) and the execution of further functions take place in a similar manner.

A prior art passive keyless entry system (see U.S. Pat. No. 4,942,393 and European patent application EP 0 343 619 A2) has a portable transmitter, which transmits coded RF signals. Within a reception area, the transmitter is automatically identified, and a motor vehicle is locked or unlocked automatically. In order to save the transmitter energy, the transmission is carried out at a fixed carrier frequency below the AM radio band. A method which utilizes only a very narrow bandwidth is used for modulation (PSK, phase shift keying).

A remote access control system is likewise known from U.S. Pat. No. 6,218,929 (German patent application DE 198 25 821 A1), which has a portable transmitter with a locking switch. When the switch is operated, a motor vehicle is instructed to lock itself. However, the motor vehicle is not unlocked for as long as the transmitter still remains in the vicinity, and this is done only when the transmitter approaches the motor vehicle. In this case, signals are transmitted at two fixed carrier frequencies, to be precise at 400 MHz and 2.45 GHz.

In one prior art toll-fee payment system (see U.S. Pat. No. 6,018,641 and European patent application EP 0 802 497 A1), a signal is transmitted from a toll station as a spread signal. A receiver on a board processes the signal and transmits a response back at a fixed carrier frequency, by means of which an identification code and the corresponding toll station are identified.

At least in the first polling process, which results in access to the vehicle being allowed or refused, the transceiver (transmitter/receiver) unit in the vehicle must in principle respond to all the smart cards that are allowed for that vehicle, in order to confirm whether access to the vehicle is being requested with one of them—and with which one. This polling and/or the responses are carried out sequentially in accordance with the prior art: the access code transmitters (also referred to as “ID transmitters”) are either activated and polled sequentially, or the ID transmitters respond sequentially to a common “wake-up signal” in timeslots assigned to them.

According to the specifications from the vehicle manufacturers, only a short time interval (typically 200 ms) is available for the entire response process and for evaluating the incoming response or responses up to and including activation of the opening mechanism, since it is not intended to be possible for the user to perceive that a comprehensive datan interchange is taking place between the base station in the vehicle and his smart card, and since the user should not be able to perceive any detectable waiting time before access is allowed. The summation of the response times is becoming increasingly critical for compliance with this time limit, especially as the amount of information to be transmitted by the access code or ID transmitters increases.

### SUMMARY OF THE INVENTION

It is accordingly an object of the invention to provide a remote access control system, including a method and a configuration for carrying out the method, which overcomes the above-mentioned disadvantages of the heretofore-known devices and methods of this general type and speeds up the method sequence considerably without any significant increase in the technical complexity and costs.

With the foregoing and other objects in view there is provided, in accordance with the invention, a method for remote access control, which comprises:

providing a configuration having a transceiver unit for transmitting an interrogation signal and for receiving access code signals, and having an evaluation unit connected to the transceiver unit, for evaluating received access code signals and for outputting an access enable or inhibit signal in dependence on an evaluation result, and having a number of access code transmitters for receiving the interrogation signal and for transmitting a respective specific access code signal in reaction to receiving the interrogation signal;

outputting with the transceiver unit an interrogation signal configured to activate all the access code transmitters at the same time;

transmitting with each of the access code transmitters receiving the interrogation signal a respectively specific access code signal, substantially simultaneously; and

receiving the access code signals with the transceiver unit substantially simultaneously, and separating the access code signals on a basis of specific spread sequences applied to the signals.

The invention includes the basic idea of allowing both phases of the communication process between the vehicle unit and the access code transmitters which can potentially be responded to to take place in parallel. That is, the access code transmitters are addressed by a common interrogation signal and they respond at the same time, with their transmission signals having a characteristic applied to them, which allows them to be processed in parallel in the vehicle unit.

In accordance with one preferred embodiment, this characteristic is a specific spread spectrum sequence, by means of which the data in the access code is/are processed in the ID transmitter (the smart card). Corresponding means are provided in the vehicle unit for despreading the received spread data or access code signal. Since different spread sequences must be provided for application to the access code for the individual access code transmitters, all the permissible spread sequences must be provided in the vehicle. It is thus necessary for at least parts of the vehicle receiving unit to be designed as mutually parallel components. Since, however, the systems under discussion are not low-cost systems and the primary factor is the potential advantage of achieving additional functionality, this complexity is in principle acceptable—although it can be kept low by suitable choice of the spread coding method.

From this point of view, the DSSS (Direct Sequence Spread Spectrum) method is particularly suitable, since, in this case, only one RF receiving section (front end) is required, and the additional complexity for the various reception paths is restricted to baseband, that is to say to the digital signal processing area, where it can be minimized by using specific very large scale integrated circuits. Identical RF assemblies can also be used for the various ID transmitters at the transmitter end, with different spread sequences just being used for producing the spread data signal in baseband (which can be done using software).

However, in principle, it may also be worthwhile using different spread spectrum methods, for example using what is referred to as the chirp method, wherein the carrier frequency is increased or decreased in the course of a data message, with this increase or decrease being reversed by means of time-variant filters (surface acoustic wave filters) in the receiver used for received signal processing. Since multiple filter structures are required in the RF area to do this, the complexity of the receiver end is in principle somewhat greater—however, technological progress will have a cost-reducing effect even here, especially with surface acoustic wave filters being produced on ceramic substrates. The method can likewise be accomplished by means of frequency hopping spread spectrum methods. In this case, a large number of possible transmission channels at different frequencies are available, to which jumps are made at the transmitter end—once again subject to a spread sequence. The signals from the various transmitters can be separated once again in the receiver by means of correlation.

With the above and other objects in view there is also provided, in accordance with the invention, a remote access control configuration, in particular a configuration for carrying out the above-outlined method. The configuration comprises:

a transceiver unit having an interrogation signal transmitter for generating and transmitting an interrogation signal, and a receiver for receiving access code signals, said receiver having at least one section with a device for parallel processing of a plurality of received access code signals in accordance with specific spread sequences superimposed on the access code signals;

a plurality of access code transmitters each having a receiving and activation unit for receiving the interrogation signal and for controlling an output of the respective access code signal, a memory for storing specific spread sequences to be superimposed on the access code, and a transmission stage including a processing unit for superimposing the specific spread sequences to the access code.

In other words, the configuration for carrying out the novel method comprises—as is already fundamentally evident from what has been said above with regard to the method—a number of access code transmitters which, in addition to a memory for the actual access code, have a further memory for the additional characteristic, for example a spread code which is specific for each individual access code transmitter, and have a multiplier or modulator stage which is used to apply this characteristic, as well as having a transceiver unit (vehicle unit) for polling the individual access code transmitters and for evaluating one or more access code signals which are transmitted in response to the interrogation signal and are individualized on a transmitter-specific basis. The vehicle unit has a number of memory areas, corresponding to the number of permissible access code transmitters, for their characteristics (spread codes), and a corresponding number of filter or correlating components for processing the received signals with the stored characteristics. The vehicle unit obviously also has an interrogation signal generator and transmitter, and the access code transmitters obviously have an interrogation signal receiver matched to this, which activates the other components of the access code transmitters on receiving an interrogation signal.

Other features which are considered as characteristic for the invention are set forth in the appended claims.

Although the invention is illustrated and described herein as embodied in a method and configuration for remote access control, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a functional block diagram illustrating an overall configuration according to one embodiment of the invention;

FIG. 2 is a related illustration explaining the production of a spread data signal and the modulation of the carrier, using the same, in an access code transmitter according to one embodiment of the invention;

FIG. 3 is a functional block diagram explaining the receiver-end processing of the access code signal produced at the transmitter end in accordance with FIG. 2;

FIG. 4 is a graphical, illustrative explanation of the principle of spread sequence processing; and

FIG. 5 is a functional block diagram of a configuration, modified from that in FIG. 1, for use of a specific algorithm.

### DESCRIPTION OF THE PREFERRED EMBODIMENTS

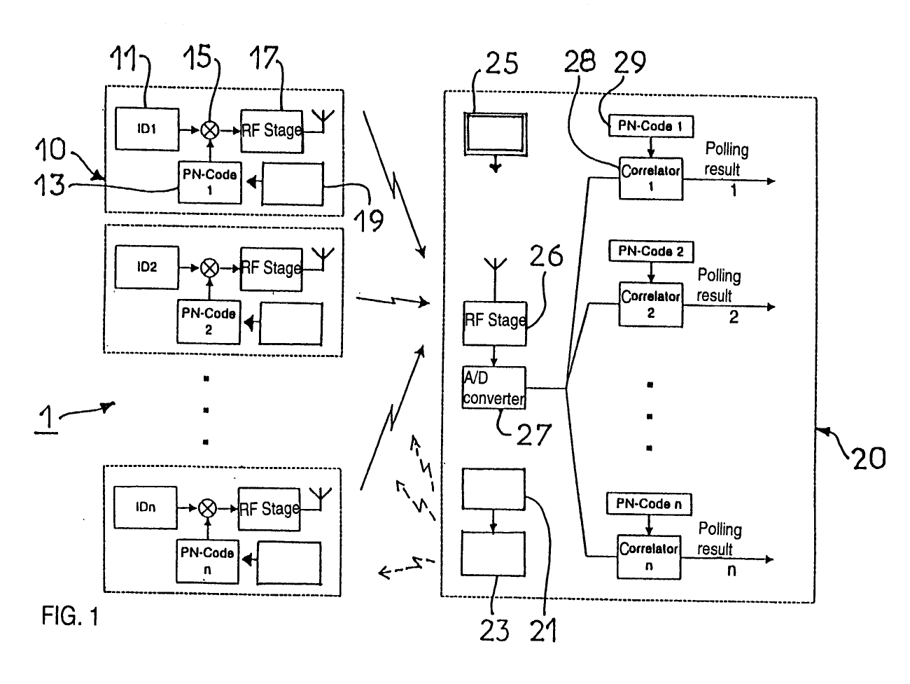

Referring now to the figures of the drawing in detail and first, particularly, to FIG. 1 thereof, there is shown a passive entry access control configuration 1 which comprises a number of ID transmitters 10 and a vehicle unit 20, in the form of a fragmentary functional block diagram, which shows only those functional components that are essential in the context of implementing the invention. The vehicle unit 20 will also be referred to as a transceiver (transmitter/receiver) unit 20.

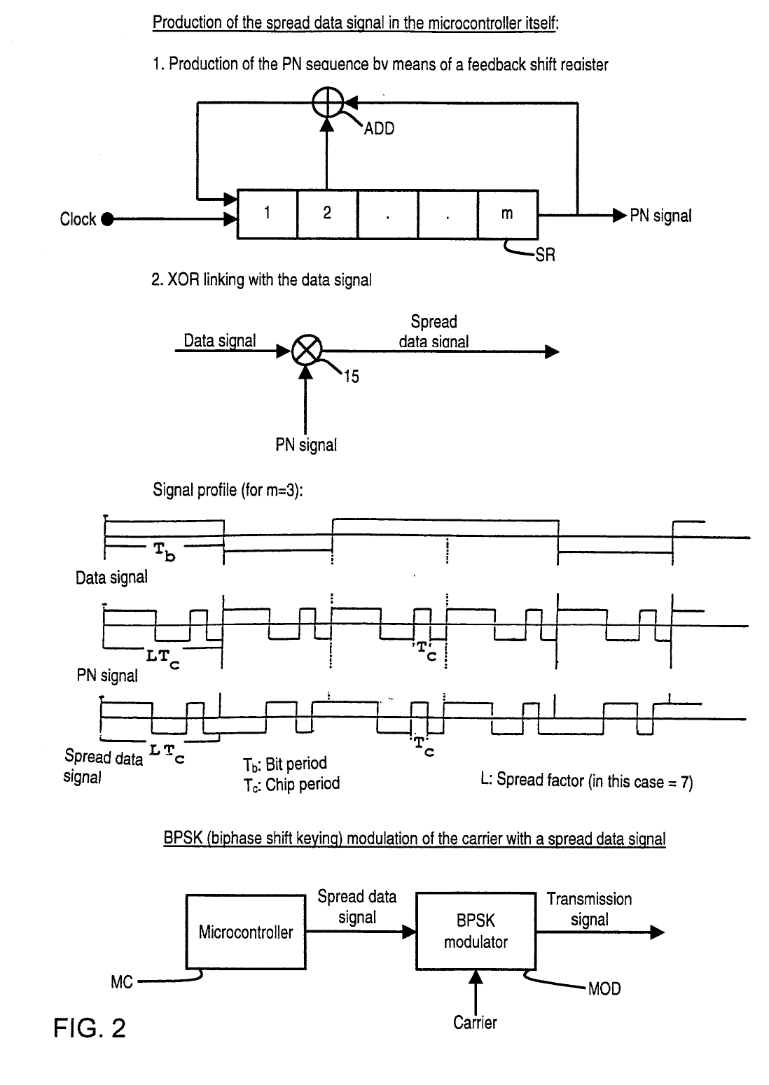

Each ID transmitter 10 comprises a data memory 11, wherein a transmitter-specific code ID1, ID2, . . . IDn is stored, and which holds not only the actual access code but also user-specific data relating to the vehicle holder. Furthermore, each ID transmitter has a PN code memory 13, wherein a respective spread code that is characteristic for that transmitter is stored. The spread code which is specified for a given ID transmitter is applied to the respective access and user code in a spread code processing stage 15 (which is symbolized as a multiplier in the figure) in each ID transmitter 10, and RF processing is carried out in a manner known per se in an RF stage 17 (which is arranged downstream from the spread code processing stage 15) to form a transmission signal, which is transmitted via a non-illustrated RF antenna. Furthermore, each ID transmitter 10 has an interrogation signal receiver 19 which, on receiving an interrogation signal (also referred to as a polling signal, request signal), activates the components mentioned above to output a response signal. The simplified block diagram representation chosen here should be understood as meaning that the interrogation signal receiver 19 has a controller for sequence control of the outputting of a response signal; details of the function complexes for interrogation signal reception and response signal control are known per se, and therefore do not need to be explained in any more detail. The signal processing sequence, which is essential in the context of implementation of the invention, in the ID transmitter 10 is explained in more detail in FIG. 2 and in the associated description further below.

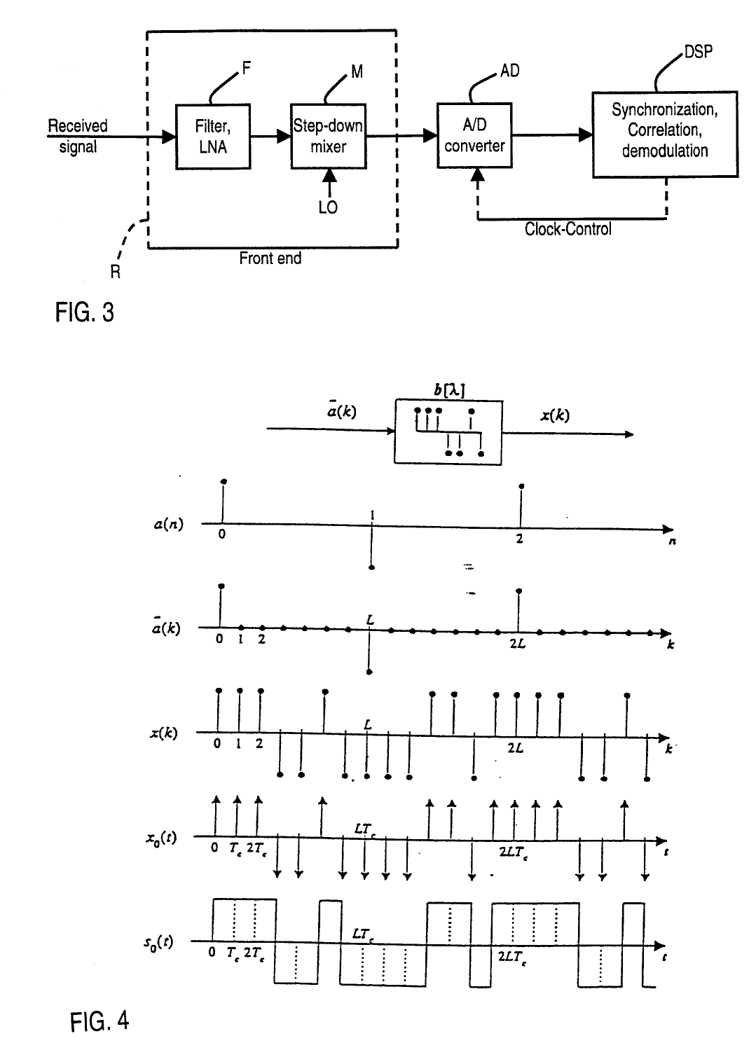

The vehicle unit 20 comprises an interrogation signal generator 21 and an interrogation signal transmitter 23, connected to the output of the interrogation signal generator 21, in order to produce the interrogation signal. Existing systems use relatively low frequencies (for example 125 kHz, inductive transmission) for this interrogation signal in order to accurately limit the area wherein the interrogation signal is effective, with the signal being transmitted by antennas (not shown here) in parts of the bodywork of a vehicle. In principle, however, any desired transmission path is feasible for this interrogation signal. To this extent, the operation of the access control configuration 1 is also known per se and does not need to be explained in any more detail. The essential feature is that, on receiving a corresponding initiation signal (for example from a pushbutton on the door handle of the vehicle), a microcontroller 25 in the vehicle unit 20 causes an individual, generally applicable interrogation signal to be produced by the interrogation signal generator 21 for all the ID transmitters 10, and at the same time controlling parallel processing of the response signals arriving in response to this from the ID transmitters. The response signals are in turn received in a manner known per se via an RF antenna, are processed at RF in an RF stage 26, and are digitized in an A/D converter 27 connected downstream from the RF stage. As illustrated in the figure, the digitization process is followed by parallel processing in a number of correlator stages 28 corresponding to the number n of permissible ID transmitters 10, with despreading in each case being carried out by means of the spread code which was used for spreading at the transmitter end and is stored in a vehicle spread code memory 29 in the vehicle unit. This process is sketched once again in FIG. 3, and further below in the description. This process results in the despread access and user codes ID1, ID2 and IDn, which are referred to in FIG. 1 as the “polling result 1”, “polling result 2” and, respectively, “polling result n”, from the ID transmitters which are located in the polling area of the vehicle unit 20 and which transmit a response signal, for further processing and checking in a manner known per se, with these responses being provided at the same time according to the invention, and the access code processing thus being speeded up. The method of digital signal processing (DSP) illustrated in FIG. 1 represents the fundamental principle of the preferred embodiment. The DSP algorithm can be modified depending on the computation capacity in order to carry out application-specific optimization functions. For example, the dynamic range can be extended by methods such as “Multiuser Detection of CDMA by Iterated Soft-Cancellation (Turbo Multiuser Detection)”. The relevant literature contains a large number of approaches for such optimization options.

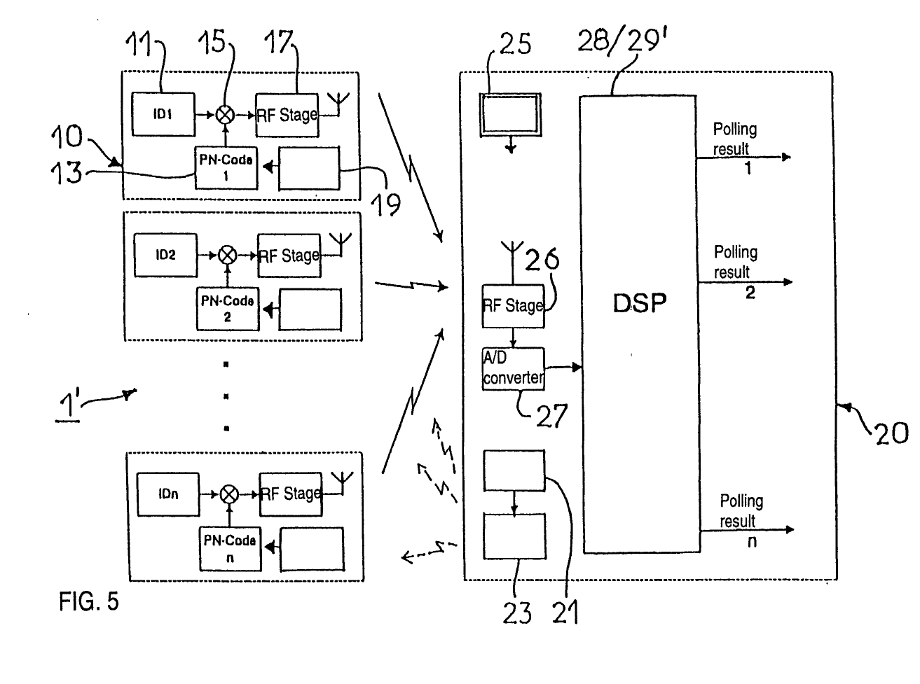

In general, the digital signal processing can no longer be split into individual, independent branches. The configuration sketched in FIG. 1 would then be in the form, shown in FIG. 5, of a modified configuration 1′ with DSP processing block 28/29′ for parallel digital processing of the received signal. FIG. 5 requires no further explanation, against the background of the above explanation of FIG. 1.

FIG. 2 illustrates the individual stages for producing a spread data signal (access and user code), which is carried out in an advantageous manner in the logic and/or digital processing area of ID and/or access code transmitter 10. First of all, a spread code “PN signal” is produced from a clock signal “clock” in the manner sketched in the upper part of FIG. 2 by means of a feedback shift register SR and an addition stage ADD. The spread code obtained during this process is then linked, by multiplication, to the actual data signal in the processing stage 15 (see FIG. 1). The signal profile of the data signal, of the spread code and of the spread data signal is shown—using a simplified example—in the three timing diagrams in the central area of FIG. 2.

The lower area of FIG. 2 shows the final step of BPSK modulation of an RF carrier with the spread data signal (obtained in the microcontroller MC) in a BPSK modulator MOD in order to obtain a transmission signal.

FIG. 3 shows (once again in the form of an outline sketch) how the signal received in the vehicle unit 20 (FIG. 1) is subjected, in a single receiving section (front end) R, to filtering in a filter stage F and further processing in a step-down mixer M, arranged downstream from this, before the signal is subjected to digitization in an A/D converter AD (corresponding to the block 27 in FIG. 1), and is subjected to logical processing in the logical processing stage DSP, which at the same time supplies the sampling signal for the A/D converter AD, with synchronization, correlation and demodulation for recovery of the access and user code.

FIG. 4 shows a sketch, in somewhat more detail, of one example of spread code processing, as it is carried out in the processing stages 15 of the ID transmitters 10 at the transmitter end in the access control configuration 1 shown here, and which corresponds to the corresponding despreading at the receiver end in the correlator stages 29 in the vehicle unit 20.

For simplicity, it is assumed that the access code to be transmitted is given by a sequence a(n) of bits which are at a time interval of, or have a symbol duration of, T. It is also assumed that the symbol duration T is equal to the time interval T_{b} between two source symbols and that a(n) is formed from bipolar values +1, −1, which are assumed to occur with the same probability. The spreading process in the model illustration includes the following step: first of all, the sequence ã(k) is produced by step-up sampling with the spread factor L. This is done by inserting (L−1) zeros at the same interval as the chip duration T_{c} between two respective values of a(n). The association between the spread sequence and the individual bits is in this model regarded as filtering of the step-up-sampled bit sequence ã(k) using an FIR filter. The filter coefficients of this FIR filter are the L bipolar elements of the spread sequence b (which is shown in the box in the first line in FIG. 4). The sequence x(k) produced during the spreading process is now wherein by the spread sequence. A D/A converter converts the sequence x(k) to a sequence x₀(t) of dirac pulses with a time interval T_{c}, and this is followed by a pulse forming with a freely variable pulse shape to form a transmission signal s₀(t), which is represented mathematically as the result of convolution of x₀(t) and the inverse Fourier transform of the frequency response of the pulse forming process. (To simplify the illustration, this model does not include modulation onto a carrier frequency.)

The implementation of the invention is not restricted to the described exemplary embodiments or to the given explanatory notes. Those of skill in the pertinent art will readily understand that a large number of modifications are likewise possible.

We claim:

1. A method for remote access control, which comprises:
providing a configuration having a transceiver unit for transmitting an interrogation signal and for receiving access code signals, and having an evaluation unit connected to the transceiver unit, for evaluating received access code signals and for outputting an access enable or inhibit signal in dependence on an evaluation result, and having a number of access code transmitters for receiving the interrogation signal and for transmitting a respective specific access code signal in reaction to receiving the interrogation signal;
outputting with the transceiver unit an interrogation signal configured to activate all the access code transmitters at the same time;
transmitting with each of the access code transmitters receiving the interrogation signal a respectively specific access code signal, substantially simultaneously; and
receiving the access code signals with the transceiver unit substantially simultaneously, and separating the access code signals on a basis of specific spread sequences applied to the signals.

2. The method according to claim 1, which comprises providing the configuration for radio access control to a motor vehicle, and utilizing the separated access code signals for enabling access to an interior of the motor vehicle or for activating an operating function of the motor vehicle.

3. The method according to claim 1, which comprises subjecting the access code signals to different spread sequences of spread spectrum processing in the access code transmitters and dispreading the access code signals in the transceiver unit using a respective corresponding inverse spread sequence.

4. The method according to claim 1, which comprises spread spectrum processing in the access code transmitters with a DSSS method, and carrying out digital signal processing in the transceiver unit for spreading in baseband.

5. The method according to claim 4, which comprises using mutually orthogonal spread sequences as the characteristic in the DSSS method.

6. The method according to claim 3, which comprises applying chirp sequence processing for spread spectrum processing in the access code transmitters, and applying corresponding delay-time-dependent filtering in an RF section in the transceiver unit.

7. The method according to claim 3, which comprises applying frequency-hopping processing for spread spectrum processing in the access code transmitters, and applying corresponding frequency-hopping dispreading in the transceiver unit.

8. A remote access control configuration, comprising:
a transceiver unit having an interrogation signal transmitter for generating and transmitting an interrogation signal, and a receiver for receiving access code signals, said receiver having at least one section with a device for parallel processing of a plurality of received access code signals in accordance with specific spread sequences superimposed on the access code signals;
a plurality of access code transmitters each having a receiving and activation unit for receiving the interrogation signal and for controlling an output of the respective access code signal, a memory for storing specific spread sequences to be superimposed on the access code, and a transmission stage including a processing unit for superimposing the specific spread sequences to the access code.

9. The configuration according to claim 8, wherein said transceiver unit is disposed in a motor vehicle and configured to control an access to the vehicle or to selectively activate an operating function of the motor vehicle, and said access code transmitters are portable units enabling access to the motor vehicle.

10. The configuration according to claim 8 configured for carrying out the method according to claim 1.

11. The configuration according to claim 8, wherein said interrogation signal transmitter in said transceiver unit, and said receiving and activation units in said access code transmitters are configured for inductive signal transmission.

12. The configuration according to claim 8, wherein said interrogation signal transmitter in said transceiver unit, and said receiving and activation units in said access code transmitters are configured for inductive signal transmission at a carrier frequency of 125 kHz.

13. The configuration according to claim 8, wherein said receiver in said transceiver unit, and said transmission stages in said access code transmitters are configured for carrying out UHF radio transmission.

14. The configuration according to claim 13, wherein said receiver in said transceiver unit, and said transmission stages in said access code transmitters transmit at 433.

15. The configuration according to claim 13, wherein said receiver in said transceiver unit, and said transmission stages in said access code transmitters transmit at 868 MHz.

16. The configuration according to claim 8, wherein said receiver in said transceiver unit has sections for parallel processing of different access code signals in baseband.

17. The configuration according to claim 16, wherein said receiver in said transceiver unit has a device for direct sequence spreading of an appropriately spread access code signal.

18. The configuration according to claim 8, wherein said receiver in said transceiver unit has sections for parallel processing of different access code signals in the RF stage.

19. The configuration according to claim 8, wherein said receiver in said transceiver unit includes time-variant filter components for despreading chirp-spread access code signals.
